(19) United States
(12) Patent Application Publication
(10) Pub. No.: US 2026/0220058 A1
(43) Pub. Date: Jul. 30, 2026

(54) ALIAS RELATIONSHIP VISUALIZER

(71) Applicant: Yokogawa Electric Corporation, TOKYO (JP)

(72) Inventor: Patrick Clay, Frisco, TX (US)

(21) Appl. No.: 19/025,820

(22) Filed: Jan. 16, 2025

(51) Int. Cl. G06F 13/20; G06F 9/451

(52) U.S. Cl. CPC G06F 13/20; G06F 9/451; G06F 2213/0052

(57) ABSTRACT

Methods, systems, and apparatus are disclosed for rendering a visualization of alias relationships of one or more components. A client device may receive alias information from an alias name service (ANS) of a global discovery server (GDS) and may render content based on the received alias information. For example, a client device otherwise limited to exclusively providing content indicating a component’s default nomenclature (e.g., “DCN 132.546”), e.g., without alias information, may instead provide aliased content indicative of a component’s function (e.g., “DCN Water Filtration”). Further, a client device otherwise limited to exclusively providing textual content may instead provide graphic content (e.g., schematics, flowcharts, etc.) in addition to and/or in lieu of the textual content based on received alias information.

### BACKGROUND

Process automation facilities may include a myriad of sensors, actuators, and distributed control nodes (DCNs) that cooperate to perform a variety of different tasks, including managing process control loops. Tracking these nodes using traditional node identifications (IDs) may present various challenges. Connection strings (e.g., IP addresses, including TCP ports) of individual nodes, as well as node IDs used to identify individual components that are accessible via those nodes, are not readily-interpretable by humans, and do not easily scale.

### SUMMARY

Implementations are described herein for generation of visual alias relationship data, which may be processed in furtherance of rendering a visualization of aliases of one or more components of a process automation facility, as well as relationships between the components represented by those aliases. For instance, some process automation facilities may implement an Open Platform Communications Unified Architecture (OPC UA) that includes a Global Discovery Server (GDS). The GDS may provides an Alias Name Service (ANS) that facilitates the mapping of aliases (strings of characters that are human-readable/meaningful) to connection strings and node IDs. In other words, the GDS can act like a “phone book” for OPC UA clients. Techniques described herein may give rise to various technical advantages. For example, techniques described herein may reduce aggregate consumption of computing resources responsive to unnecessarily extended interactions by one or more users.

A visual mapping of aliases and relationships between them may be rendered in lieu of and/or in addition to more cryptic nomenclature often assigned to process automation components. Generation and rendering of visual mappings of alias relationships may enable one or more users to more efficiently identify components (such as DCNs) when a problem is detected, and therefore reduce iterative requests for (and computational provisions of) textual recitals of components which would otherwise be necessary for a user to identify relationships between components. A visual mapping of alias relationships may be depicted via various graphical user interfaces (GUIs).

In some implementations one or more processors may identify one or more of: a first input/output (I/O) alias that corresponds to a first I/O channel provided by a first DCN of a process automation facility, one or more function blocks (FBs) that are operably coupled with the first I/O channel corresponding to the first I/O alias, and/or one or more other DCNs that host the one or more FBs. In response to identifying one or more of the first I/O alias, the one or more FBs, and/or the one or more other DCNs one or more processors may generate data operable to render a GUI that may depict a visual mapping between the first I/O alias and the one or more FBs, and may further depict one or more visual annotations indicating which of the one or more other DCNs hosts each of the one or more FBs. One or more processors may, responsive to receiving user input, cause the GUI to be rendered at a display of a computing device.

In some implementations, the GUI may depict an additional visual annotation indicating that the first DCN hosts the first I/O alias. In some implementations, the first I/O alias may be situated upstream from the one or more FBs, and the method may further include identifying one or more additional I/O aliases that are operably coupled to, and situated downstream from, one or more of the FBs. In some implementations, the first I/O alias may be situated downstream from the one or more FBs, and the method may further include identifying one or more additional I/O aliases that are operably coupled to, and situated upstream from, one or more of the FBs. In some implementations, identifying one or more of the first I/O alias, the one or more FBs, and/or the one or more other DCNs may be based on processing Global Discovery Server (GDS) data corresponding to one or more of the first I/O alias, the FBs, or the DCNs. In some implementations, the one or more FBs may be identified as function block aliases. In some implementations, the one or more visual annotations may include brackets that span two or more graphical elements representing two or more of the FBs.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts an example environment in which selected aspects of the present disclosure may be implemented.

FIG. 2A depicts an example GUI in which a graphical representation of a physical component hosting a DCN may be rendered along with an indication of a selection of a I/O channel corresponding to the physical component.

FIG. 2B depicts an example GUI in which aliases associated with one or more DCNs and one or more FBs may be rendered.

FIG. 2C depicts another example GUI in which aliases associated with one or more DCNs and one or more FBs may be rendered.

FIG. 3A depicts an example GUI which may not include component aliases.

FIG. 3B depicts an example GUI which may include component aliases.

FIG. 3C depicts an example GUI which may include component aliases and groupings of components.

FIG. 3D depicts an example GUI which may include component aliases of a particular group along with an indication of additional components included in the particular group.

FIG. 4 depicts an example flowchart for performing aspects of the present disclosure.

FIG. 5 schematically illustrates an example computer architecture on which selected aspects of the present disclosure may be implemented.

### DETAILED DESCRIPTION

Implementations are described herein for generation of visual alias relationship data, which may be processed in furtherance of rendering a visualization of aliases of one or more components of a process automation facility, as well as relationships between the components represented by those aliases. Implementations described herein may reduce unnecessary consumption of computing resources associated with the aggregation of iterative user requests provided in furtherance of obtaining documents which may be used to identify relationships between one or more computing components. Accordingly, implementations described herein may decrease latency between an initial user request provided in furtherance of identifying relationships between one or more computing components and a final response thereto.

A DCN may include one or more input-output (I/O) channels associated with various types of equipment in a process automation facility. Output channels may be associated with output devices such as actuators, valves, dampers, etc. Input channels may be associated with input devices such as various types of sensors, flow meters, compute nodes, etc. In some implementations, I/O channels may connect a DCN with one or more function blocks hosted by another DCN. A DCN may drive output channel(s) controlling output device(s) based on data received from one or more data sources, such as one or more remote DCNs (or components thereof) to which the DCN is subscribed.

Process automation equipment such as DCNs may be configured to communicate with other process automation equipment using various open (e.g., non-proprietary) and/or standardized communication protocols, which will be described herein as “cross-platform.” Cross-platform communication protocols may be governed by various regulations and/or standards, such as the Open Platform Communication (OPC) Unified Architecture (UA). Thus, while in various examples described herein, a DCN may be described as hosting one or more “OPC UA clients” and/or one or more “OPC UA servers,” this is not meant to be limiting. DCNs may host other types of cross-platform clients and/or cross-platform servers; OPC UA is just one example.

DCNs may host various cross-platform clients (CPCs) and/or cross-platform servers (CPSs), which may use features of a DCN (e.g., I/O channels) to monitor and/or control various process automation equipment. While CPCs/CPSs (and/or function block-based applications associated with them) may be capable of monitoring and/or controlling equipment using IP addresses, serial numbers, etc., these may be difficult for a human user to retain and process. Accordingly, aliases may enable humans to more intuitively identify and manage components.

Aliases may be associated with various components of a process automation facility, and may include readily interpretable strings of characters, such as “Valve1” or “Sensor2 I/OChannel”. Additionally, aliases may identify component functions and/or relationships between one or more components, such as “Water Filtration”, “Valve Control”, “Pump Control”, etc. These aliases may be generated with or without user input. For example, these aliases may be automatically generated by a component within a process automation network and/or may be generated based on user input received by a component in communication with the process automation network.

In some instances, an alias may change. For example, an alias may be altered, reassigned, orphaned, and/or deleted. These changes may be responsive to various events, such as components being added, removed, and/or replaced. These changes may also be implemented with or without user input. Consequently, there may be a frequent communication and/or synchronization between GDSs and components to address these changes. A GUI that visualizes alias relationships between one or more components for a user may be updated responsive to these changes. For example, if an alias relationship included a first DCN aliased as “Water Filtration”, a downstream second DCN aliased “Pump Control”, and the first and second DCN were physically switched, then a graphical user interface may be updated to depict water filtration as now being downstream from pump control, e.g., indicating that a change from the DCN aliased as pump control may be used to control a process of the DCN aliased as water filtration. Similarly, DCNs may not be physically moved and/or modified, but may be assigned to a new and/or additional function, may be assigned to a new and/or additional alias, etc., which may also be reflected in an alias relationship visualization rendered via a GUI.

Techniques described herein enable visualization of alias information to reduce latency between an initial user request and final response, and reduce consumption of computing resources associated with requesting textual documentation associated with computing components. Visualization may be based on temporal considerations (e.g., time frames), roles played in an industrial facility (e.g., participant in a process control loop), attributes of components/equipment (e.g., individually or by groups), security, manufacturer, locations, etc.. GDSs may record resources (e.g., sensors or actuators managed by CPSs) and aliases assigned to those resources. GDSs may also record other information, such as timestamps, grouping information, etc., associated with receipt and/or recordation of resources and aliases.

As an example, a user may request an alias visualization for a DCN, e.g., aliased as “Water Filtration”. The GDS may return only those aliases that are used in conjunction with, e.g., FindAlias(“[^^] WaterFiltration”). As a consequence, data returned by the GDS will include alias information associated with the DCN aliased “Water Filtration”, and based on settings, may also include alias information for upstream and/or downstream components as well. Accordingly, in the aggregate, latency and consumption of computational resources will decrease as a visualization of the DCN aliased “Water Filtration” will circumvent and/or mitigate additional requests for documentation (e.g., made in furtherance of otherwise identifying DCNs associated with the “Water Filtration” DCN via textual document analysis).

As another example, a user may may specify a group associated with the alias visualization, e.g., a group to which a plurality of components, such as DCNs, are assigned e.g. FindAlias(“[^^]GROUPID Filtration”). As a consequence, the data returned by the GDS may not include alias information that is not associated with the DCNs outside of the Filtration Group. Rather, data returned by the GDS may include alias information exclusively associated with DCNs in the filtration group, and based on settings, may also include alias information for upstream and/or downstream components as well.

As another example, a user may may specify a timeframe during which alias information was active. The GDS may return only those aliases that were active during the specified timeframe, e.g. FindAlias(“[^^]Between 2023-01-02T14:40:00-2024-01-02T14:40:00”). As a consequence, the data returned by the GDS will not include alias information outside of that timeframe. This may allow a user to determine historical alias information associated with one or more components, which may be helpful for troubleshooting a problem (e.g., in the case that a component was moved, replaced, etc.).

In some implementations, a client device may be configured to receive a list of registered aliases from a GDS, the list including resources hosted by DCNs on the process automation network and aliases assigned to the resources. The list of registered aliases may be recorded at the client device. Periodically, a client device may request an updated list of registered aliases. The GDS may return less than all registered aliases based on one or more aliases previously provided not having been subsequently updated. This may avoid return of registered aliases that have not changed relative to a previous request, and thus reduce transmissions over the process automation network.

Criteria associated with a component’s alias may cause one or more aliases to be included and/or excluded from an alias relationship visualization. For example, criteria may be specified for alias relationship visualization such that alias information not satisfying the criteria may be excluded in an alias relationship visualization. Criteria may include a temporal criteria corresponding to one or more components (e.g., a timestamp associated with generation, modification, updating, and/or verification of an alias), active state criteria corresponding to one or more component activities, performance criteria corresponding to one or more component performance measures, security criteria corresponding to one or more component security levels, grouping criteria corresponding to an organization and/or hierarchy of one or more components, etc. Using temporal criteria as an example, an alias of a DCN may be associated with a timestamp indicating when the alias was generated, modified, updated, verified, etc. The criteria may be satisfied based on the alias of the DCN being up-to-date, e.g., being the most recent alias assigned to the component.

Aliases may be modified over time, and an alias name service (ANS) may compile an updated list of aliases that may include registered aliases that are modified, added, and/or deleted since the time associated with receiving a previous list of registered aliases. For example, subsequent to receiving the list of registered aliases, one or more selected registered aliases may be assigned to a resource hosted by another DCN on the process automation network and may be included in the updated list. As another example, subsequent to receiving the list of registered aliases, one or more of the registered aliases may be unassigned from one or more of the resources hosted by the other DCNs and may be included in the updated list.

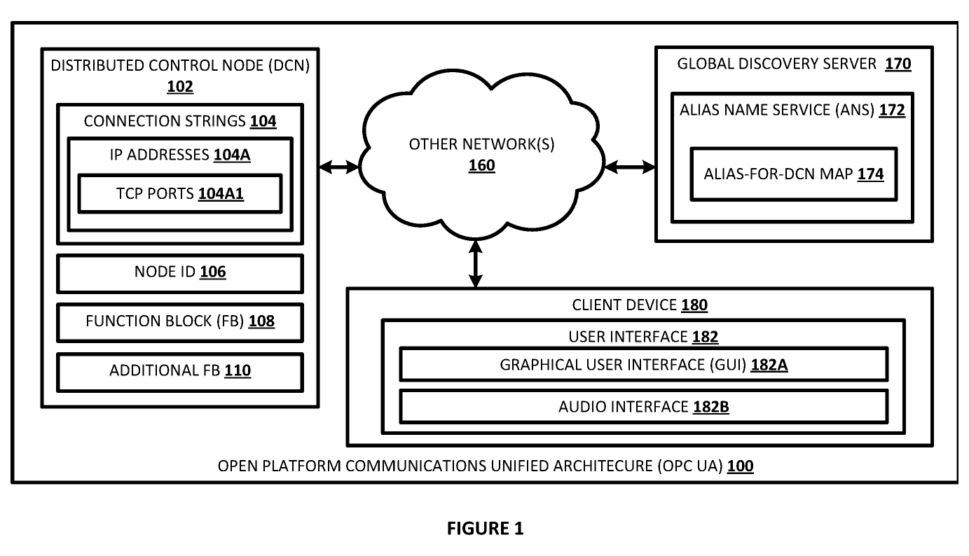

FIG. 1 schematically depicts an example environment in which selected aspects of the present disclosure may be implemented, in accordance with various embodiments. An OPC UA 100 may include one or more components, including a DCN 102, a GDS 170, and a client device 180, which may be connected via one or more networks 160.

DCN 102 may store in memory one or more connection strings 104, node IDs 106, and/or function blocks (FB) 108-110. Connection strings 104 may include IP addresses 104A and TCP ports 104A1.

GDS 170 may include an alias name service (ANS) 172, which may include one or more alias maps for various components, such as an alias-for-DCN map 174. As discussed herein, components may be assigned cryptic nomenclature, e.g., that may be efficiently processed by a computer but which may be difficult for a human to understand and/or manage. Aliases may include human-friendly characterizations of those cryptic nomenclature. As an example, alias-for-DCN map 174 may map a default identifier of DCN 102, e.g., hexadecimal code “7B316” or with an otherwise cryptic identifier (e.g., opc.tcp://10.0.1.1:4840; ns=5;i=5242), DCN 102, to an alias of “Pump Control”. Accordingly, the alias “Pump Control” may be visually rendered in lieu of and/or in addition to the default identifier, e.g., hexadecimal code “7B316”. As will be discussed in more detail subsequently, ANS 172 may also include alias information for each feature of a DCN, including I/O channels, e.g.FBs, etc.

Client device 180 may include a user interface 182, which may include a graphical user interface (GUI) 182A and/or an audio interface 182B. GUI 182A may graphically render (e.g., visualize) alias information using one or more of text, non-textual graphics, colors, patterns, etc. In some implementations, audio interface 182B may audibly render alias information independent from or in addition to GUI 182A. Audio interface 182B may audibly render content corresponding to user input directed to GUI 182A. For example, if user input is directed to a graphical representation (rendered via GUI 182A) of a DCN aliased “Water Filtration”, then audio interface 182B may audibly render content associated with the DCN, e.g., “This DCN is aliased Water Filtration, and is part of the Filtration Group”. Audio interface 182B may also provide supplementary audible content in response to a change of GUI 182A and/or an available update from GDS 170.

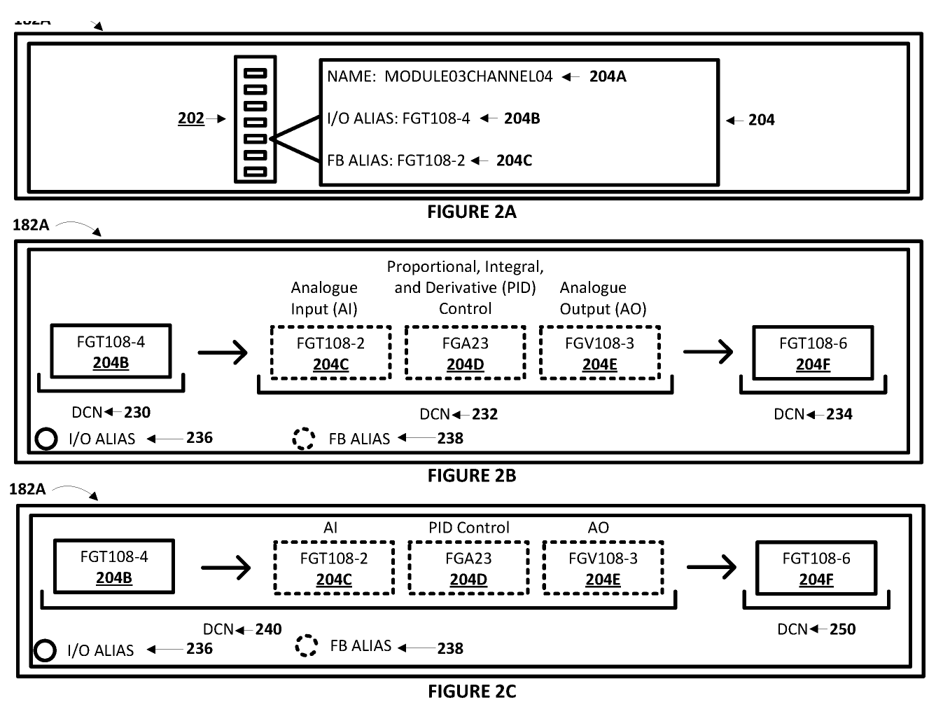

FIGS. 2A-2C depict example GUI environments. GUI environments discussed herein may be rendered via one or more graphical displays (e.g., monitor, TV, etc.) of a computing device as an output. In some implementations, output from one or more other interfaces, such as audio interfaces and/or haptic interfaces, may supplement graphical display output. GUI environments may be rendered based on timestamp information, update information, grouping information, performance information, manufacturer information, security information, etc., associated with one or more components. For example, GUI environments may be rendered based on a most recent update, previous update, specified timespan, timespan since their last known update, etc. Similarly, GUI environments may be rendered based on security protocols, e.g., not rendering content that would conflict with security protocols, rendering content indicating that a security protocol is in place, rendering content that is modified/redacted based on a security protocol, and/or rendering content based on an account type of a user.

FIG. 2A depicts a GUI 182A visualization of a server rack 202, which may host one or more DCNs. An information excerpt 204 may be rendered which indicates information associated with one or more components of server rack 202. The information excerpt 204 may be rendered based on user selection of a graphical element of the server rack visualization 202, one or more events occurring in association with a component, etc. For example, excerpt 204 may be rendered in response to a user selection (e.g., by clicking a mouse, interacting with a touch pad, providing voice input, etc.) of one or more selectable components of server rack 202. As another example, excerpt 204 may be rendered in response to an error occurring with one or more components of server rack 202 (e.g., to draw attention to the error and provide information so that a user may quickly identify and/or rectify the error). Excerpt 204 may include a component name 204A, an I/O alias 204B, and/or a FB alias 204C.

FIG. 2B depicts an example GUI 182A showing how a process flow may be implemented over a plurality of DCNs. GUI 182A depicted in FIG. 2B may be rendered when, for instance, the user selects the graphical element in FIG. 2A corresponding to the I/O alias 204B. FIG. 2B depicts a GUI 182A representation of I/O alias 204B, which communicatively connects DCN 230 with DCN 232, as being upstream in a process flow from function blocks hosted by DCN 232. DCN 232 may host three function blocks, which may include a function block corresponding to alias 204C (an analog input, or “AI”), a function block corresponding to alias 204D (proportional, integral, and derivative control, or “PID”), and a function block corresponding to alias 204E (analog output, or “AO’). DCN 232 may be communicatively coupled with DCN 234 via an I/O channel corresponding to alias 204F. A I/O alias key 236 may indicate which aliases are associated with I/O channels, e.g., 204B and 204F. A FB alias key 238 may indicate which aliases are associated with FBs, e.g., aliases 204C, 204D, and 204E.

FIG. 2C depicts GUI 182A in another state that demonstrates another example of how a process flow may be implemented over a plurality of DCNs. Unlike in FIG. 2B where alias 204B was on a separate DCN 230 from the downstream function blocks 204C-E, in FIG. 2C, alias 204B is on the same DCN 240 as downstream function blocks 204C-E. For example, GUI 182A indicates that the same DCN 240 that is equipped with an I/O channel corresponding to I/O alias 204B may also host one or more function blocks corresponding to aliases 204C, 204D, and/or 204E. DCN 250 may be connected with a I/O channel corresponding to I/O alias 204F. DCN 240 may communicate with DCN 250 based on the I/O channel corresponding to alias 204F. Accordingly, in some implementations, a GUI may indicate that a DCN hosts one or more components such as an I/O channel and/or a function block, may indicate a flow of communication for components included therein, and may include aliases associated with components therein.

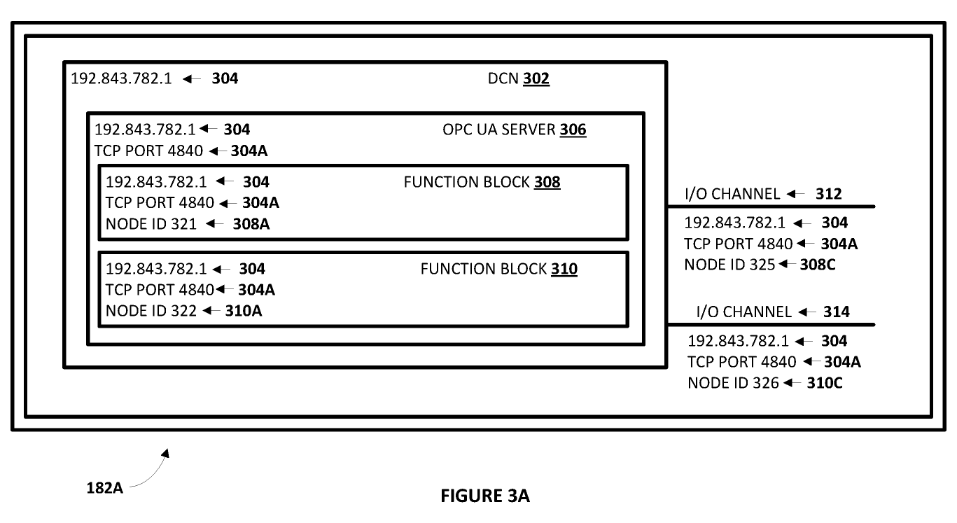

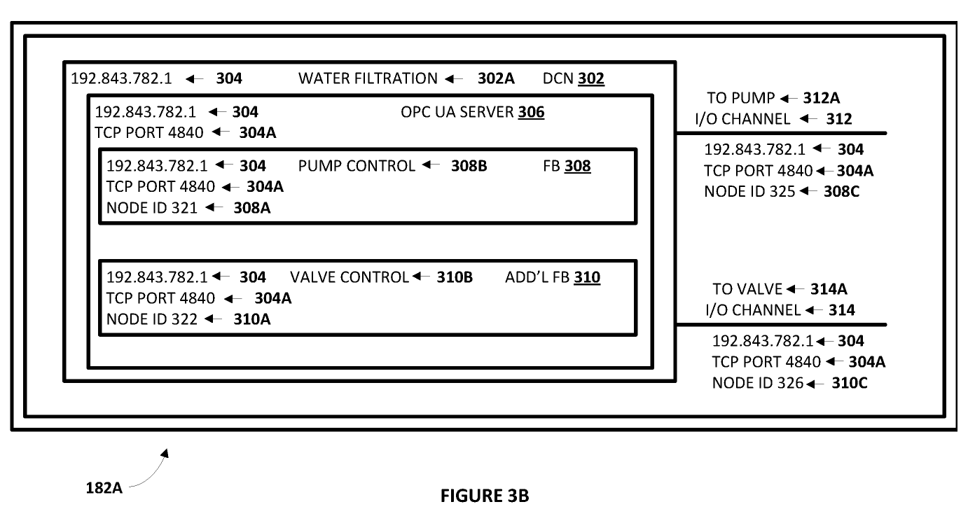

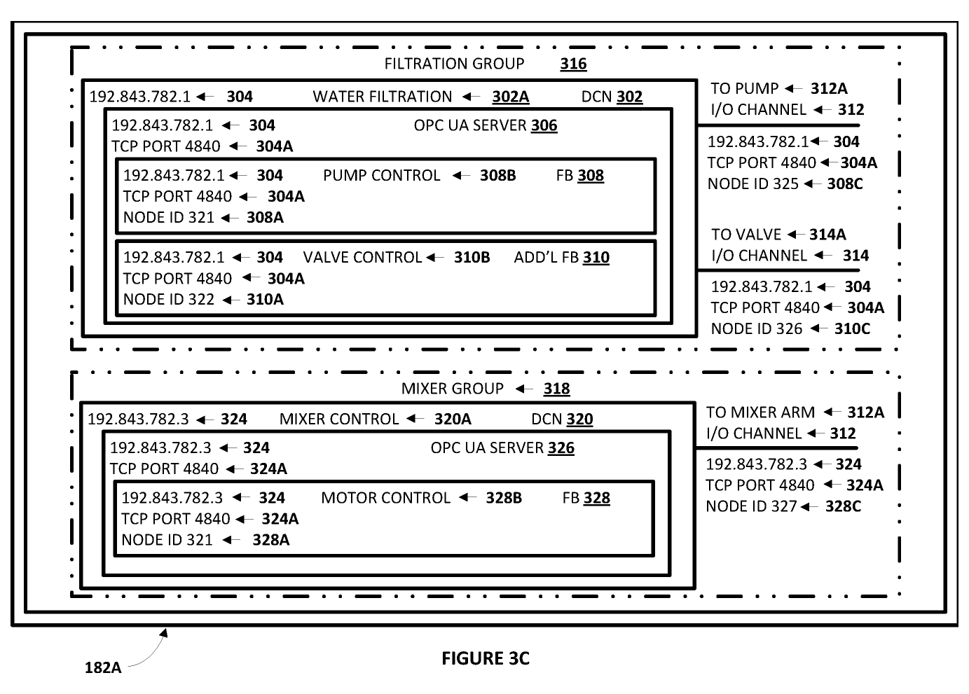

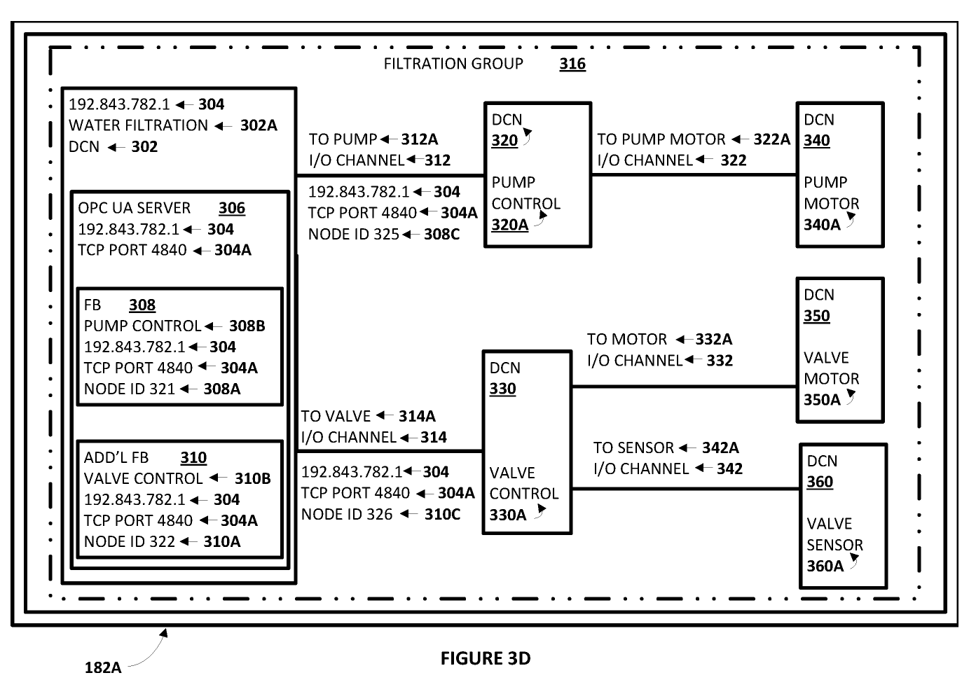

FIGS. 3A-3D also depict example GUI environments. GUI 182A, as depicted in FIG. 3A, may not include alias information, but may illustrate a graphical nesting, layering, mapping, etc., of one or more components, which may provide many benefits despite not including alias information. For example, GUI 182A may provide information about DCN 302 in a graphical format, such that features of DCN 302 are nested, layered, etc., within DCN 302 - instead of rendering purely textual documentation (which may render information about DCN 302 in a textual format independent of non-textual content). Therefore, although alias information regarding DCN 302 may not be provided, usage of computational resources and/or latency between a user request and a response thereto may be reduced based on the aggregation of user requests for information being reduced responsive to the improved rendering and/or dissemination of information.

The nesting of DCN 302 depicted in FIG. 3A may depict DCN 302 as a box with smaller boxes inside of it (e.g., nested), wherein each smaller box corresponds to a feature and/or sub-feature thereof. Further, components of FIG. 3A may be depicted as including non-aliased nomenclature, such as IP addresses 304 and TCP ports 304A. In some implementations, IP address 304 and/or TCP ports 304A may be shared among one or more components. DCN 302 may include OPC UA server 306, which may host function blocks 308 and/or 310. Function block 308 may be associated with a node ID 308A and function block 310 may be associated with a node ID 310A.

Although DCN 302 (and other components of FIG. 3A) may be depicted alongside an associated IP address 304, this may not intuitively and/or readily indicate a function and/or relationship relative to one or more other components included in a process. For example, the default nomenclature of “192.843.782.1” does not indicate that DCN 302 may perform, for example, “Water Filtration” and/or that it may be associated with a “Filtration” group.

The nesting of the boxes of DCN 302 may indicate that DCN 302 is reachable at IP address 304 and includes OPC UA server 306, and FBs 308 and 310. GUI 182A, as depicted in FIG. 3A, also graphically depicts I/O channels 312 and 314 stemming from DCN 302, indicating that DCN 302 sends and/or receives data via I/O channels 312 and/or 314. For example, I/O channel 312 may stem from DCN 302, and may be associated with IP address 304, TCP port 304A, and node ID 308C. As another example, I/O channel 314 may stem from DCN 302, and may be associated with IP address 304, TCP port 304A, and node ID 310C. Similar to DCN 302, the features of I/O channels 312 and 314 may be referenced using default nomenclature. Graphical representation indicating that DCN 302 uses two separate I/O channels may provide a benefit even when alias information is not present (e.g., efficiently visually indicating that two I/O channels 312 and 314 are in communication with DCN 302).

As will be discussed in more detail subsequently, alias information may be selectively provided, such that alias information may be provided for DCN 302, function block 308, and/or additional function block 310. Client device 180 (which may render GUI 182A) may receive alias information from ANS 172, including alias-for-DCN map 174, which may be processed in furtherance of rendering GUI 182A. For example, GUI 182A may render non-textual graphical content (in addition to and/or independent of textual content) based on data received from ANS 172 via GDS 170.

FIG. 3B depicts the example GUI of FIG. 3A that is updated to provide alias information. For example, GUI 182 depicts DCN 302 alongside alias 302A “Water Filtration”. Function block 308 includes as alias 308B “Pump Control”, additional function block 310 includes an alias 310B “Valve Control”, I/O channel 312 includes an alias 312A “To Pump”, and I/O channel 314 includes an alias 314A “To Valve”. Additionally, some features may be assigned aliases that may not be rendered (e.g., based on account and/or security configurations).

The alias information included in FIG. 3B may simplify management of process automation facility resources for human users, e.g., by making it easier and/or more efficient for humans to track down which physical hardware (e.g., DCN) is hosting a resource (e.g., a function block or I/O channel) that is creating problems. For example, a function of a DCN may not be readily identifiable by a human user based on default nomenclature (e.g., “192.843.782.1” associated with IP address 304, “321” associated with Node ID “308A”, etc.), but may be readily identifiable based on the alias information (e.g., “Water Filtration”) provided. Accordingly, sequential requests for additional content associated with a component in furtherance of identifying features and/or functions of the component may be mitigated and/or circumvented responsive to content rendered based on alias information preemptively identifying features and/or functions (e.g., rendering further requests for information regarding components and/or features moot).

FIG. 3C depicts an example GUI environment in which one or more components are grouped. For example, DCN 302 may be associated with alias 302A “Water Filtration” and may be included in a group with the alias 316 of “Filtration Group”. DCN 320 may be associated with the alias 320A “Mixer Control” and may be included in the group with the alias 318 “Mixer Group.” DCN 320 may be associated with an IP address 324, an OPC UA server 326 (which may include IP address 324 and TCP port 324A), and FB 328 (which may be associated with alias 328B “Motor Control” and node ID 328A). DCN 320 may be connected with I/O channel 312, which may be associated with alias 312A “To Mixer Arm”, IP address 324, TCP port 324A, and node ID 328C.

Grouping of components may improve efficient recognition that the two components are associated with related but separate groups, such as water filtration and mixing. Grouping of components may be based on components physically located in a same area, being associated with a overarching process, being selected for monitoring, etc. Grouping may be included in alias information for one or more components. Grouping may be generated and/or modified with or without user input (e.g., grouping, like other alias information, may be generated in full and/or in part by one or more processors based on available information).

FIG. 3D depicts another example of GUI 182A. GUI 182A may render content associated with upstream and/or downstream components related to DCN 302. For example, DCN 302 may include I/O channel 312 aliased “To Pump”, which connects DCN 302 with DCN 320 which is associated with alias 320A “Pump Control”, which may itself may be connected with I/O channel 322 associated with alias 322A “To Pump Motor”, which connects DCN 320 with DCN 340 which is associated with alias 340A “Pump Motor”.

As another example, DCN 302 may be connected with I/O channel 314 associated with alias 314A “To Valve”, which connects DCN 302 to DCN 330 associated with alias 330A “Valve Control”. DCN 330 may connect with I/O channel 332 that may be associated with alias 332A “To Motor”, which may connect DCN 330 to DCN 350 associated with alias 350A “Valve Motor”. I/O channel 342 may be associated with alias 342A “To Sensor”, and may connect DCN 330 to DCN 360 associated with alias 360A “Valve Sensor”. Accordingly, the GUI 182A of FIG. 3D may provide a readily interpretable stream of components of the filtration group, which a user may use in furtherance of monitoring, upgrading, replacing, repairing, etc., one or more components of a group.

For example, in a scenario a filtration process may be malfunctioning due to a faulty component. Rather than GUI 182A rendering purely textual content which a user may iteratively request more of in furtherance of identifying a function, location, etc., GUI 182A may render graphical content in lieu of and/or in addition to textual content. Instead of the user iteratively parsing through and (by aggregate) requesting more textual content in furtherance of identifying functions and relationships of components, a user may parse GUI 182A including alias information and efficiently obtain information regarding functions and/or relationships of components without subsequent requests for additional content.

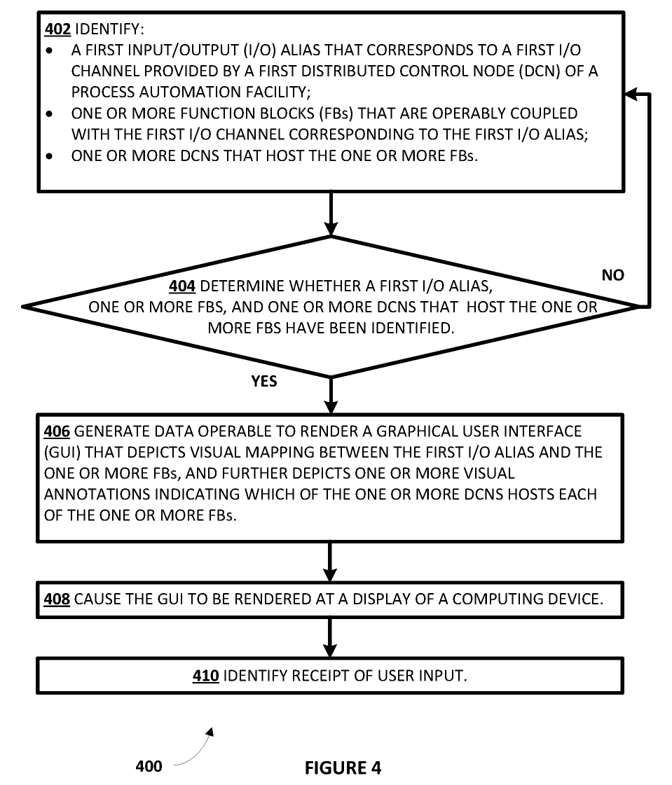

FIG. 4 depicts a flowchart 400 of an example method which may be implemented by one or more processors. The method may begin at block 402, in which a processor may identify a first input/output (I/O) alias that corresponds to a first I/O channel provided by a first distributed control node (DCN) of a process automation facility. This I/O alias may be identified in various ways. For example, a user could interact with a GUI like the one depicted in FIGS. 2A-2C and/or FIGS. 3A-3D to select a graphical element that represents the I/O alias. Block 402 may also include identifying one or more function blocks (FBs) that are operably coupled with the first I/O channel corresponding to the first I/O alias, and one or more DCNs that host the one or more FBs.

In some implementations, the first I/O alias may be situated upstream from the one or more FBs, and the operations of block 402 may further include identifying one or more additional I/O aliases that are operably coupled to, and situated downstream from, one or more of the FBs. In some implementations, the first I/O alias is situated downstream from the one or more FBs, and the operations of block 402 may further include identifying one or more additional I/O aliases that are operably coupled to, and situated upstream from, one or more of the FBs.

In some implementations, identifying one or more of the first I/O alias, the one or more FBs, or the one or more DCNs may be based on processing Global Discovery Server (GDS) data corresponding to one or more of the first I/O alias, the FBs, or the DCNs. In some implementations, the one or more FBs are identified as function block aliases. For example, once the I/O alias is identified, it may be used to identify the underlying I/O channel of the DCN. The I/O alias and/or the underlying I/O channel it represents may be used to identify one or more of the function blocks that are operable coupled with the first I/O channel. In some implementations, this may be accomplished by querying GDS 170 for aliases of any components (e.g., function block(s)) that subscribe to the first I/O alias. The aliases of these subscribing components may then be used to lookup which DCN hosts them, e.g., by performing a reverse ANS lookup.

At block 404, a processor may determine whether a first I/O alias, one or more FBs, and one or more DCNs that host the one or more FBs have been identified. If the processor determines that a first I/O alias, one or more FBs, and one or more DCNs that host the one or more FBs have been identified then the method may proceed to block 404. If the processor determines that a first I/O alias, one or more FBs, and one or more DCNs that host the one or more FBs have not been identified then the method may revert back to block 402.

At block 406, a processor may generate data operable to render a GUI that depicts a visual mapping between the first I/O alias and the one or more FBs, and further depicts one or more visual annotations indicating which of the one or more DCNs hosts each of the one or more FBs. In some implementations, the GUI may depict an additional visual annotation indicating that the first DCN hosts the first I/O alias. In some implementations, the one or more visual annotations may include brackets that span two or more graphical elements representing two or more of the FBs.

At block 408, a processor may cause the GUI to be rendered at a display of a computing device. At block 410, a processor may identify whether user input is received. Responsive to user input, the GUI may be altered. For example, the GUI may be altered based on selection of a new I/O port as the starting point.

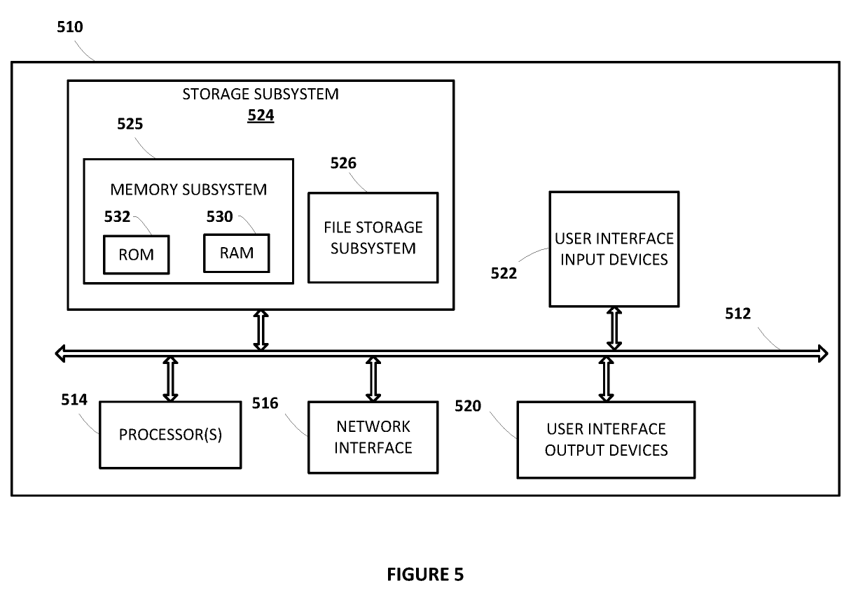

FIG. 5 is a block diagram of an example computing device 510 that may optionally be utilized to perform one or more aspects of techniques described herein. Computing device 510 typically includes at least one processor 515 which communicates with a number of peripheral devices via bus subsystem 512. These peripheral devices may include a storage subsystem 525, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term "input device" is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term "output device" is intended to include all possible types of devices and ways to output information from computing device 510 to the user or to another machine or computing device.

Storage subsystem 525 stores programming and data constructs that provide the functionality of some or all of the modules described herein. For example, the storage subsystem 525 may include the logic to perform selected aspects of the method depicted in FIG. 5, as well as to implement various aspects depicted in FIGS. 1-4.

These software modules are generally executed by processor 515 alone or in combination with other processors. Memory 525 used in the storage subsystem 525 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 525, or in other machines accessible by the processor(s) 515.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5. Techniques disclosed herein may be implemented by one or more processors, systems including storage devices with instructions executable by one or more processors, and/or non-transitory computer readable mediums storing instructions executable by one or more computers.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A method implemented using one or more processors and comprising:
identifying:
a first input/output (I/O) alias that corresponds to a first I/O channel provided by a first distributed control node (DCN) of a process automation facility;
one or more function blocks (FBs) that are operably coupled with the first I/O channel corresponding to the first I/O alias; and
one or more other DCNs that host the one or more FBs;
in response to identifying the first I/O alias, the one or more FBs, and the one or more other DCNs:
generating data operable to render a graphical user interface (GUI) that depicts a visual mapping between the first I/O alias and the one or more FBs, and further depicts one or more visual annotations indicating which of the one or more other DCNs hosts each of the one or more FBs, and
causing, responsive to receiving user input, the GUI to be rendered at a display of a computing device.

2. The method of claim 1, wherein the GUI depicts an additional visual annotation indicating that one or more of the DCNs host the first I/O alias.

3. The method of claim 1, wherein the first I/O alias is situated upstream from the one or more FBs, and the method further comprises identifying one or more additional I/O aliases that are operably coupled to, and situated downstream from, one or more of the FBs.

4. The method of claim 1, wherein the first I/O alias is situated downstream from the one or more FBs, and the method further comprises identifying one or more additional I/O aliases that are operably coupled to, and situated upstream from, one or more of the FBs.

5. The method of claim 1, wherein the identifying one or more of the first I/O alias, the one or more FBs, or the one or more other DCNs is based on processing Global Discovery Server (GDS) data corresponding to one or more of the first I/O alias, the FBs, or the DCNs.

6. The method of claim 1, wherein the one or more FBs are identified as function block aliases.

7. The method of claim 6, wherein the one or more visual annotations comprise brackets that span two or more graphical elements representing two or more of the FBs.

8. A system comprising:
one or more storage devices storing instructions; and
one or more processors that are operable to execute the instruction to cause the one or more processors to:
identify:
a first input/output (I/O) alias that corresponds to a first I/O channel provided by a first distributed control node (DCN) of a process automation facility;
one or more function blocks (FBs) that are operably coupled with the first I/O channel corresponding to the first I/O alias; and
one or more other DCNs that host the one or more FBs;
in response to identifying the first I/O alias, the one or more FBs, and the one or more other DCNs:
generate data operable to render a graphical user interface (GUI) that depicts a visual mapping between the first I/O alias and the one or more FBs, and further depicts one or more visual annotations indicating which of the one or more other DCNs hosts each of the one or more FBs, and
cause, responsive to receiving user input, the GUI to be rendered at a display of a computing device.

9. The system of claim 8, wherein the GUI depicts an additional visual annotation indicating that one or more of the DCNs hosts the first I/O alias.

10. The system of claim 8, wherein the first I/O alias is situated upstream from the one or more FBs, and the wherein the instructions further cause the one or more processors to identify one or more additional I/O aliases that are operably coupled to, and situated downstream from, one or more of the FBs.

11. The system of claim 8, wherein the first I/O alias is situated downstream from the one or more FBs, and the wherein the instructions further cause the one or more processors to identify one or more additional I/O aliases that are operably coupled to, and situated upstream from, one or more of the FBs.

12. The system of claim 8, wherein the identifying one or more of the first I/O alias, the one or more FBs, or the one or more other DCNs is based on processing Global Discovery Server (GDS) data corresponding to one or more of the first I/O alias, the FBs, or the DCNs.

13. The system of claim 8, wherein the one or more FBs are identified as function block aliases.

14. The system of claim 13, wherein the one or more visual annotations comprise brackets that span two or more graphical elements representing two or more of the FBs.

15. A non-transitory computer-readable medium storing software comprising instructions executable by one or more processors which, upon such execution, cause the one or more processors to perform operations comprising:
identify:
a first input/output (I/O) alias that corresponds to a first I/O channel provided by a first distributed control node (DCN) of a process automation facility;
one or more function blocks (FBs) that are operably coupled with the first I/O channel corresponding to the first I/O alias; and
one or more other DCNs that host the one or more FBs;
in response to identifying the first I/O alias, the one or more FBs, and the one or more other DCNs:
generate data operable to render a graphical user interface (GUI) that depicts a visual mapping between the first I/O alias and the one or more FBs, and further depicts one or more visual annotations indicating which of the one or more other DCNs hosts each of the one or more FBs, and
cause, responsive to receiving user input, the GUI to be rendered at a display of a computing device.

16. The non-transitory computer-readable medium of claim 15, wherein the GUI depicts an additional visual annotation indicating that one or more of the DCNs hosts the first I/O alias.

17. The non-transitory computer-readable medium of claim 15, wherein the first I/O alias is situated upstream from the one or more FBs, and the wherein the instructions further cause the one or more processors to identify one or more additional I/O aliases that are operably coupled to, and situated downstream from, one or more of the FBs.

18. The non-transitory computer-readable medium of claim 15, wherein the first I/O alias is situated downstream from the one or more FBs, and the wherein the instructions further cause the one or more processors to identify one or more additional I/O aliases that are operably coupled to, and situated upstream from, one or more of the FBs.

19. The non-transitory computer-readable medium of claim 15, wherein the identifying one or more of the first I/O alias, the one or more FBs, or the one or more other DCNs is based on processing Global Discovery Server (GDS) data corresponding to one or more of the first I/O alias, the FBs, or the DCNs.

20. The non-transitory computer-readable medium of claim 15, wherein the one or more FBs are identified as function block aliases.
